(19) United States
(12) Patent Application Publication
(10) Pub. No.: US 2008/0217044 A1
(43) Pub. Date: Sep. 11, 2008

(54) COUPLED BUILDING WIRE ASSEMBLY

(75) Inventors: John R. Carlson, Newnan, GA (US); Charles D. Mercier, Carrollton, GA (US); Mark D. Dixon, Carrollton, GA (US); Randy D. Kummer, Villa Rica, GA (US); John W. Armstrong, Villa Rica, GA (US)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(73) Assignee: Southwire Company, Carrollton, GA (US)

(21) Appl. No.: 11/967,802

(22) Filed: Dec. 31, 2007

Related U.S. Application Data
(63) Continuation-in-part of application No. 11/056,492, filed on Feb. 11, 2005, now abandoned.
Application No. 11/056,492 is a continuation of application No. 11/055,951, filed on Feb. 11, 2005, now abandoned.
Application No. 11/055,951 is a continuation of application No. 11/760,344, filed on Jun. 8, 2007.
Application No. 11/760,344 is a continuation of application No. 11/423,193, filed on Jun. 9, 2006, now abandoned.
Application No. 11/423,193 is a continuation of application No. 10/955,436, filed on Sep. 30, 2004, now abandoned.
(60) Provisional application No. 60/544,294, filed on Feb. 12, 2004.
(60) Provisional application No. 60/544,224, filed on Feb. 12, 2004.
(60) Provisional application No. 60/517,851, filed on Nov. 6, 2003.
(60) Provisional application No. 60/508,148, filed on Oct. 1, 2003.

(51) Int. Cl. H01B 7/00

(52) U.S. Cl. 174/113 R

(57) ABSTRACT

A coupled building wire assembly is provided wherein more than one length of NM cable having the same or different gauges are coupled together that permits one to pull multiple lengths of cable from a single coil. The exterior surfaces of the coupled building wire assembly is also coated with a lubricant or has its outer sheaths incorporating the sufficient lubricant, which either migrates to the sheaths' surfaces or permeates such sheaths.

### RELATED APPLICATIONS

This application is a continuation-in-part application of copending U.S. patent application Ser. No. 11/056,492, filed Feb. 11, 2005, which claims benefit of priority to U.S. provisional application No. 60/544,294, filed Feb. 12, 2004; in combination with copending U.S. patent application Ser. No. 11/055,951, filed Feb. 11, 2005, which claims benefit of priority to U.S. provisional application No. 60/544,294, filed Feb. 12, 2004; in combination with copending U.S. patent application Ser. No. 11/423,193, filed Jun. 9, 2006, which is a continuation of U.S. patent application Ser. No. 10/955,436, filed Sep. 30, 2004, now abandoned, which claims benefit of priority to U.S. provisional application Ser. No. 60/508,148, filed Oct. 1, 2003, and to U.S. provisional application Ser. No. 60/517,851, filed Nov. 6, 2003, all of which are incorporated by reference herein and to which priority is claimed.

### FIELD OF THE INVENTION

The present invention relates generally to electrical wire and cable, and more particularly to electrical wire and cable, and methods for manufacturing same, to facilitate their being pulled through structures.

### BACKGROUND

Sheathed cable, particularly non-metallic (“NM”) sheathed cable is suitable for use in concealed or exposed, dry, protected areas, for example, inside stud walls and on the sides of joists, and is commonly used to provide electrical power throughout structures built in the United States. NM cable is installed during the construction phase of a building, home, or other structure by pulling a length of cable from a coil into the structure and through openings or bores formed in the structure's internal framing elements, cutting the cable at its desired length, and connecting the cable to various components, such as outlet boxes, junction boxes, switches, and fixtures.

Conventional NM cable is sold as a single unit in that each coil contains one length of cable (a “circuit”) that has a uniform gauge or size. Consequently, when an electrician needs to install more than one circuit at once, the electrician must pull each circuit from a separate coil. The use of multiple separate coils, particularly when more than one gauge of cable is required, is a significant burden that requires extra set up time and often results in the undesirable entanglement of multiple lengths of cable. By way of example, in a typical home, each room has lighting elements that require one gauge of cable and electrical outlets that require a different gauge of cable. In particular, a 15-amp circuit used for lighting will employ a 14 American Wire Gauge (“AWG”) NM cable, but a 20-amp circuit used for electrical outlets will employ a 12 AWG NM cable. Thus, during construction, a length of 14 AWG NM cable and a length of 12 AWG NM cable will need to be pulled into each room, which conventionally requires the set up and use of more than one coil. As another example, a single room may need more than one dedicated 15-amp circuit, thereby requiring that more than one length of 14 AWG NM cable be pulled into the room.

### SUMMARY

Disclosed herein are multiple embodiments of a coupled building wire assembly wherein more than one length of cable having the same or different gauges are uniquely coupled together permitting one to pull multiple lengths of cable from a single coil, thereby avoiding many of the disadvantages associated with the prior art. A particular feature of the invention disclosed herein is where such coupled building wire assembly has its exterior surfaces coated with a lubricant to reduce the exterior surface coefficient of friction and thereby reduce required installation pulling forces. As an alternative, the lubricant for the exterior surfaces of the coupled building wire assembly is provided by introducing sufficient lubricant into the outer sheaths during the cables' manufacture that reduces the coefficient of friction of the exterior surface of the coupled building wire assembly.

### BRIEF DESCRIPTION OF THE DRAWINGS

FIG. 1 is a cross-sectional view of a length of non-metallic sheathed cable that may be used in the various embodiments described herein.

FIG. 2 is a cross-sectional view of a length of a coupled building wire assembly according to a first embodiment hereof.

FIG. 3 is a cross-sectional view of a length of a coupled building wire assembly according to a second embodiment hereof.

FIG. 4 is a cross-sectional view of a length of a coupled building wire assembly according to a third embodiment hereof.

FIG. 5 is a cross-sectional view of a length of a coupled building wire assembly according to a fourth embodiment hereof.

### DETAILED DESCRIPTION

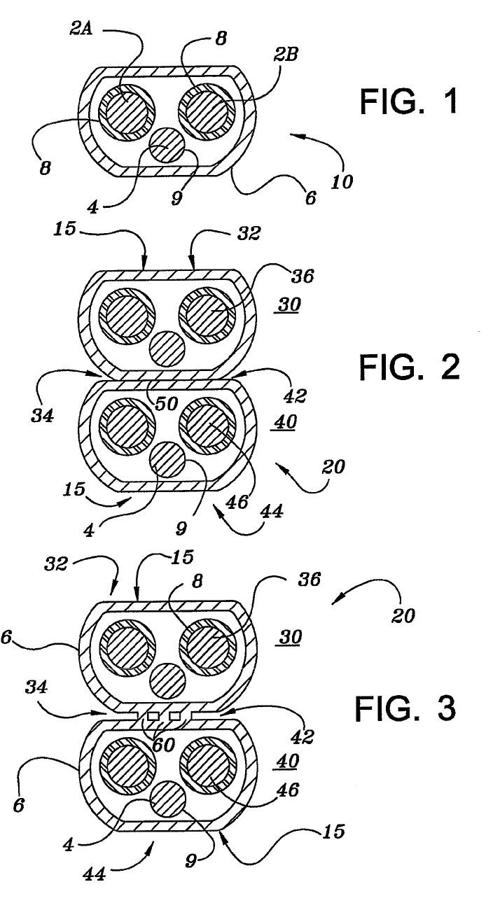

With reference to FIG. 1, a length of non-metallic (“NM”) sheathed cable 10 comprises two circuit conductors 2A and 2B, a grounding conductor 4, and an outer sheath 6. The two circuit conductors 2A and 2B and the grounding conductor 4 are generally constructed of copper or aluminum alloys and may be of sizes 14 American Wire Gauge (“AWG”) to 2 AWG. An outer sheath 6, preferably constructed of polyvinyl chloride (“PVC”), provides overall protection for the cable components. Each circuit conductor 2A and 2B is wrapped in insulation 8 that is constructed of PVC. The grounding conductor 4 may be wrapped in paper 9 to prevent contact with the outer sheath 6 and the insulation 8.

With reference to the embodiment of the coupled building wire assembly 20 illustrated in FIG. 2, the assembly has a first length of NM cable 30 having a top surface 32 and a bottom surface 34, a second length NM cable 40 having a top surface 42 and a bottom surface 44, wherein the bottom surface 34 of the first length of NM cable 30 is coupled to the top surface 42 of the second length of NM cable 40. The first length of NM cable 30 comprises at least one circuit conductor 36 having a first gauge and the second length of NM cable 40 comprises at least one circuit conductor 46 having a second gauge.

In the illustrated embodiment, the first gauge of the at least one circuit conductor 36 of the first length of NM cable 30 is substantially equal to the second gauge of the at least one circuit conductor 46 of the second length of NM cable 40. In other embodiments, the first gauge of the at least one circuit conductor 36 of the first length of NM cable 30 is unequal to the second gauge of the at least one circuit conductor 46 of the second length of NM cable 40.

With continuing reference to the embodiment of FIG. 2, the bottom surface 34 of the first length of NM cable 30 is coupled to the top surface 42 of the second length of NM cable 40 using a cementitious material 50. In accordance with this embodiment, the cementitious material 50 is applied to either the bottom surface 34 of the first length of NM cable 30 or to the top surface 42 of the second length of NM cable 40, or both. The bottom surface 34 of the first length of NM cable 30 and the top surface 42 of the second length of NM cable 40 are then pressed together to form the coupled building wire assembly 20. It will be appreciated that the cementitious material 50 may be any suitable cement-like substance such as PVC cement or the like.

With reference to the embodiment of the coupled building wire assembly 20 illustrated in FIG. 3, the bottom surface 34 of the first length of NM cable 30 is coupled to the top surface 42 of the second length of NM cable 40 using glue 60. In accordance with this embodiment, the glue 60 is applied to either the bottom surface 34 of the first length of NM cable 30 or to the top surface 42 of the second length of NM cable 40 as a non-continuous bead or as a continuous bead. The bottom surface 34 of the first length of NM cable 30 and the top surface 42 of the second length of NM cable 40 are then pressed together to form the coupled building wire assembly 20. It will be appreciated that the glue 60 may be a soft glue or a hard glue.

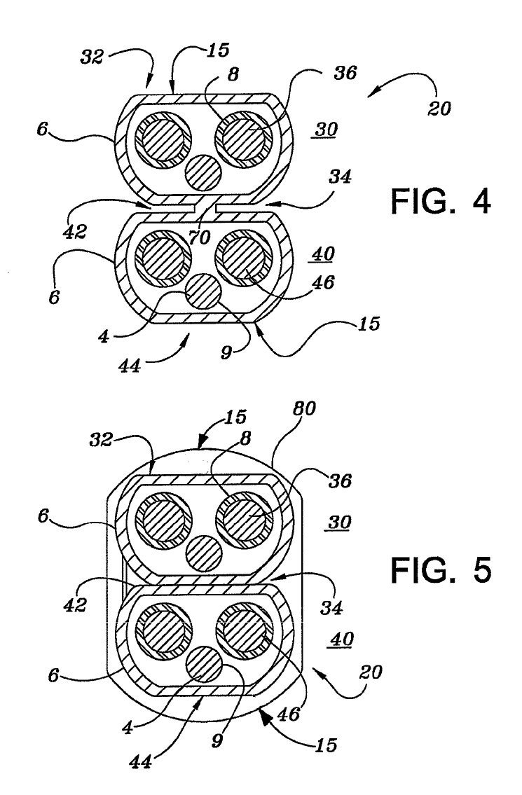

With reference to the embodiment illustrated in FIG. 4, the bottom surface 34 of the first length of NM cable 30 is coupled to the top surface 42 of the second length of NM cable 40 using a webbing material 70. In accordance with this embodiment, an extrusion machine is employed to apply the webbing material 70 to the bottom surface 34 of the first length of NM cable 30 and the top surface 42 of the second length of NM cable 40. The bottom surface 34 of the first length of NM cable 30 and the top surface 42 of the second length of NM cable 40 are then pressed together to form the coupled building wire assembly 20. It will be appreciated that the webbing material 70 may be any suitable substance such as polypropylene webbing or the like.

With reference to the embodiment illustrated in FIG. 5, the bottom surface 34 of the first length of NM cable 30 is coupled to the top surface 42 of the second length of NM cable 40 using heat shrinkable insulation 80. In accordance with this embodiment, the first length of NM cable 30 and the second length of NM cable 40 are wrapped together using a material constructed of PVC or polyolefin that, when subjected to an elevated temperature, draws in tightly around the cables 30 and 40. The heat shrinkable insulation 80 may be transparent for allowing visibility of the cables 30 and 40 and the circuit conductors 36 and 46, thereby providing electricians with the ability to distinguish such elements based on color. In still another embodiment, the first length of NM cable 30 and the second length of NM cable 40 are held together using an overall jacket, or tube.

Various other means may be used to join cables 30 and 40 together. For example, with reference to FIG. 3, the bottom surface 34 of the first length of NM cable 30 may be coupled to the top surface 42 of the second length of NM cable 40 using at least two complementary strips of Velcro®-like material, in other words, material having complementary parts which adhere to each other when pressed together and adapted for use as a fastener. In accordance with this approach, at least one strip of Velcro®-like material is placed along the bottom surface 34 of the first length of NM cable and at least one complementary strip of Velcro®-like material is placed along the top surface of the second length of NM cable. The bottom surface 34 of the first length of NM cable 30 and the top surface 42 of the second length of NM cable 40 are then pressed together to adhere the complementary parts of the Velcro®-like material to each other to form the coupled building wire assembly 20.

Alternatively, the bottom surface 34 of the first length of NM cable 30 may be coupled to the top surface 42 of the second length of NM cable 40 using a self-locking threaded fastener. In accordance with this embodiment, a self-locking threaded fastener, such as that commonly known by the trademark ZIPLOC®, is attached to the bottom surface 34 of the first length of NM cable 30 and to the top surface 42 of the second length of NM cable 40. The bottom surface 34 of the first length of NM cable 30 and the top surface 42 of the second length of NM cable 40 are then pressed together to lock the self-locking fastener and form the coupled building wire assembly 20. It will be appreciated that the self-locking fastener could be attached during assembly of the coupled building wire assembly 20 or formed into the outer sheath 6 of the first 30 and second 40 lengths of cable by incorporating the self-locking fastener into extrusion tooling.

In still other alternatives, the bottom surface 34 of the first length of NM cable 30 may be removably or permanently coupled to the top surface 42 of the second length of NM cable 40 using any other suitable adhesive material or other means, such as double-sided tape, an adhesive polymeric strip, a binding strip (constructed of mylar, polyester, string or the like), welding (such as hot air welding, ultrasonic welding, solvent bonding or the like), or any combination of the above.

It will be appreciated that each of the aforementioned embodiments allow for easy separation of the first length of NM cable 30 from the second length of NM cable 40 once the coupled building wire assembly has been pulled into the building or home that is under construction. Further, the preferred bonded embodiments offer an inherent tangle-resistance feature thereby reducing and possibly eliminating the problems of multiple cables tangling up during installation. Because the tangling of NM cable is a result of the wire conductors' radii memory, in other words, the tendency to remain coiled and resist straightening, the embodiments disclosed herein eliminate any competing radii memory by providing more than one circuit in the same package and stored with the same radius.

In order to test whether the coupled building wire assembly 20 provided an advantage over conventional single building wire constructions, a test was conducted in which electricians were asked to pull test cables into an eight (8) foot by sixteen (16) foot mock building using an electrical wiring diagram. To establish a baseline, electricians pulled circuits having a single length of NM cable into the mock building according to the diagram, and the time to complete the tasks was recorded. Then, electricians pulled the various embodiments of the coupled building wire assembly 20 described above into the mock building according to the same diagram, and the time to complete the tasks was recorded. Significant time reductions were achieved, in many instances of up to about 60%, over that of pulling only single length NM cable.

In accordance with a unique feature of the various embodiment of the coupled building wire assembly illustrated herein, the exterior surfaces of the sheath 6 (and therefore the outer surface of the coupled building wire assembly) is provided with a lubricating coating to reduce the coefficient of friction of said outer surface to reduce the required pulling forces necessary to install the assembly. In accordance with a first method for providing such lubrication, and by reference to FIGS. 2-5, at least a portion of the top surface 32 of the exterior sheath 6 of the first length of NM cable 30 and at least a portion of the bottom surface 44 of the exterior sheath 6 of the second length of NM cable 40 are covered with a lubricant coating 15. It will be appreciated that additional surfaces of the sheath of the first length of NM cable 30 and/or the second length of NM cable 40, (or outer shield insulation 80 shown in FIG. 5), may be partly, substantially, or completely covered with the lubricant coating 15.

The lubricant coating 15 may be any suitable substance that provides a thin film on the surface of the coupled building wire assembly 20 to enhance lubricity and lower the coefficient of friction. For example, the lubricant coating 15 may comprise an external release agent manufactured by Axel Plastics Research Laboratories, Inc. and sold under the trade name MoldWiz™. Alternately, the lubricant coating 15 may comprise an aqueous emulsion of resins and at least one surfactant in a water vehicle, or may comprise an emulsion of organic esters, cross-linked polyolefins, fatty acids, and at least one surfactant in a water vehicle. Alternatively, the lubricant coating 15 may comprise a water-and-isopropylalcohol-based dispersion manufactured by E. I. du Pont de Nemours and Company and sold under the trade name DryFilm WDL905, or the lubricant coating 15 may comprise water, at least one siloxane polymer, isopropyl alcohol, and poly-TFE, omega-hydro-alpha-(methylcyclohexyl).

The lubricant may be selected from the group consisting essentially of fatty amides, hydrocarbon oils, fluorinated organic resins, and mixtures thereof. Advantageous fatty amides and metallic fatty acids include, but are not limited to erucamide, oleamide, oleyl palmitamide, stearyl stearamide, stearamide, behenamide, ethylene bisstearamide, ethylene bisoleamide, stearyl erucamide, erucyl stearamide, and the like. Advantageous hydrocarbon oils include, but are not limited to, mineral oil, silicone oil, and the like. Suitable compounds also include plasticizers, dibasic esters, silicones, anti-static amines, organic amines, ethanolamides, mono- and di-glyceride fatty amines, ethoxylated fatty amines, fatty acids, zinc stearate, stearic acids, palmitic acids, calcium stearate, lead stearate, saturated fatty esters, unsaturated fatty esters, and mixtures thereof with and without modified organic acid derivatives, fatty acid amides, amide waxes, stearates, siloxanes, sulfates such as zinc sulfate, and the like. These may be used individually or in combination. Additional suitable lubricants include fluorinated organic resins, such as a polymer of one or more fluorinated monomers selected from the group consisting essentially of tetrafluoroethylene, vinylidene fluoride, chlorotrifluoroethylene and the like. The fluorinated resin may be used in the form of a powder, emulsion or aqueous dispersion.

The lubricant coating 15 may be directly applied to the coupled building wire assembly 20 by various methods, including, but not limited to, dipping the coupled wire assembly 20, or the individual lengths of cable 30 and 40 prior to being coupled, into a container of the lubricant coating 15, spraying one or more surfaces of the coupled wire assembly 20, or of the individual lengths of cable 30 and 40 prior to being coupled, with the lubricant coating 15 using a spray gun or the like, wiping or brushing the lubricant coating 15 onto one or more surfaces of the coupled wire 20, or of the individual lengths of cable 30 and 40 prior to being coupled, or depositing the lubricant coating 15 onto one or more surfaces of the coupled wire assembly 20, or of the individual lengths of cable 30 and 40 prior to being coupled, using a calibrated die or by plasma phase spraying, or with respect to the embodiment illustrated in FIG. 5, the outer most insulation layer 80, or to both the insulation 80 and exterior surfaces of the sheath 6.

According to one process, the spraying step may be carried out between the step of coating the circuit conductor 36 or 46 with plastic material and the step of cooling said material. This position of the spraying step in time is preferred, but not required, since, when the circuit conductor 36 or 46 is coated with the plastic material, said material is in a state of fusion, the high temperature of which causes volatilization of the solvents present in the lubricant coating 15, which means that there is greater adherence of said lubricant coating 15 on the surface of the plastic material. The subsequent cooling of the plastic material together with the lubricant coating 15 leads to drying on the surface, leaving the two materials bonded to form a coating of low coefficient of friction.

The building wire assembly 20 is characterized in that when externally applying the lubricant, if the outer sheath of the cable 30 and/or 40 is somewhat porous, the lubricant coating 15 will reside in the pores of the exterior surface sheath 6. The outer sheath 6 on the cable 30 and/or 40 is thus well covered with said lubricant coating 15, forming a fine layer on the plastic material, since it emerges at high pressure and the plastic material is at high temperatures.

The equipment for the manufacturing of building wire assembly 20 with the externally applied lubricant is characterized as including a device for the application of the lubricant coating 15 on the surface of the cable 30 and/or 40. Said device may be a box section through which the cable 30 or 40 passes, a plurality of nozzles for spraying the lubricant coating 15 mounted inside the box section, a tank for said lubricant coating 15, and a pressure pump to carry the lubricant coating 15 from the tank to the spraying nozzles. Moreover, the device may also include a pressure adjusting valve, a level indicator for the tank containing the lubricant coating 15, and a pressure gauge.

As an alternate process for reducing the coefficient of friction of the surface of the assembly 20, the sheaths 6 may have the lubricant material internally incorporated therein. In accordance with this approach, suitable lubricant material 15 is mixed with the material used to form each outer sheath 6 of cables 30 and 40. The step of mixing the lubricant material 15 and the sheath material may be carried out with the lubricant material 15 heated or not and the sheath material heated or not. The sheath material may be introduced in pellet form to an extruder which heats and directs the sheath material onto the portion of the cable 30 and 40 surrounding circuit conductors 36 and 46. Alternatively, lubricant material 15 may be incorporated into the sheath pellets during their formation and introducing this mixture of sheath pellets and lubricant material 15 into an extruder. Alternatively, the sheath pellets may be introduced into the extruder with the lubricant material 15 subsequently introduced into the extruder prior to contacting the portion of the cable 30 or 40 around circuit conductor 36 or 46. Moreover, it will be appreciated that the lubricant material 15 may be incorporated at any point in the manufacturing process before the formation of the outer sheath 6, and depending upon the material, may be heated prior to mixing with the sheath material. In instances where the sheath material has a high melting or softening temperature, or for other reasons such as processibility, efficiency of the process, etc., the lubricant material 15 may be added to the sheath material as the sheath material is being formed. If the final cable 30 or 40 construction is such that there are two or more different sheaths applied to the circuit conductor 36 or 46, the lubricant material 15 need only be incorporated into the outermost sheath.

The building wire assembly 20 is particularly characterized in that when incorporated in the outer sheath 6 of the individual cables 30 and 40, the lubricant material blooms and migrates toward the exterior surfaces of the cables 30 and 40, or permeates the outer sheath 6, thereby assuring its presence at the exterior surface of the sheath 6. If desired, the sheath material may be somewhat porous thereby resulting in the lubricant material 15 more readily migrating toward the exterior surface of the sheath 6.

The equipment for the manufacturing of building wire assembly 20 according to this “material” process is characterized in that it may include a device for the incorporation of a lubricant material 15 into the sheath material prior to such material's application to the circuit conductor 36 or 46. Said equipment may also include a tank to maintain the lubricant material 15, a section for mixing the lubricant material 15 and sheath material, and a section for applying the mixture to enclose the circuit conductor 36 or 46. Moreover, the equipment may also include a pressure adjusting valve(s), a level indicator(s) for the tank containing the lubricant material 15 and tank containing the sheath material, and a pressure gauge(s).

Lubricant material 15 in sheath 6 provides coupled building wire assembly 20 with a lower coefficient of friction at its outer surface than building wire lacking lubricant material 15 incorporated therein. More particularly, coupled building wire assembly 20 requires significantly less force to pull through a given structure than conventional wire, thereby reducing the installer's level of fatigue, requiring fewer climbs up ladders during installation, and allowing longer pulls of cable during installation. Accordingly, the overall time needed to install the building wire is reduced.

Various additional modifications and changes may be made to the above described embodiments without deporting from the spirit and scope of the invention, as defined by the following claims.

We claim:

1. A coupled building wire assembly comprising:
a first length of non-metallic sheathed cable having a top surface and a bottom surface;
a second length non-metallic sheathed cable having a top surface and a bottom surface;
wherein the bottom surface of the first length of non-metallic cable is releasably coupled to the top surface of the second length of non-metallic cable, wherein the first length of non-metallic cable comprises one circuit conductor having a first gauge and the second length of non-metallic cable comprises one circuit conductor having a second gauge, and wherein the first gauge of the first length of non-metallic cable is substantially equal to the second gauge of the second length of non-metallic cable.

2. A coupled building wire assembly comprising:
a first length of non-metallic sheathed cable having a top surface and a bottom surface; a second length non-metallic sheathed cable having a top surface and a bottom surface;
wherein the bottom surface of the first length of non-metallic cable is releasably coupled to the top surface of the second length of non-metallic cable, wherein the first length of non-metallic cable comprises one circuit conductor having a first gauge and the second length of non-metallic cable comprises one circuit conductor having a second gauge, and wherein the first gauge of the circuit conductor of the first length of non-metallic cable is unequal to the second gauge of the circuit conductor of the second length of non-metallic cable.

3. A coupled building wire assembly as defined in claim 1 wherein the bottom surface of the first length of non-metallic cable is coupled to the top surface of the second length of non-metallic cable by materials selected from the group consisting essentially of cementitious material, glue, webbing material, heat-shrinkable material, material having complimentary parts which adhere to each other when pressed together, self-locking threaded fasteners, adhesive material, double- sided tape, adhesive polymeric strip, binding strip, and combinations thereof.

4. A coupled building wire assembly as defined in claim 3 wherein the binding strip is constructed of mylar, polyester, string, and combinations thereof.

5. A coupled building wire assembly as defined in claim 3 wherein the binding strip is constructed of mylar, polyester, string, and combinations thereof.

6. A coupled building wire assembly comprising:
a first length of non-metallic sheathed cable having a top surface and a bottom surface;
a second length non-metallic sheathed cable having a top surface and a bottom surface;
wherein the bottom surface of the first length of non-metallic cable is releasably coupled to the top surface of the second length of non-metallic cable, wherein the first length of non-metallic cable comprises one circuit conductor having a first gauge and the second length of non-metallic cable comprises one circuit conductor having a second gauge, and wherein the first gauge of the first length of non-metallic cable is substantially equal to the second gauge of the second length of non-metallic cable;
wherein the bottom surface of the first length of non-metallic cable is coupled to the top surface of the second length of non-metallic cable by materials selected from the group consisting essentially of cementatious material, glue, webbing material, heat- shrinkable material, material having complimentary parts which adhere to each other when pressed together, self-locking threaded fasteners, adhesive material, double-sided tape, adhesive polymeric strip, binding strip, welding, and combinations thereof.

7. A coupled building wire assembly comprising:
a first length of non-metallic sheathed cable having a top surface and a bottom surface;
a second length non-metallic sheathed cable having a top surface and a bottom surface;
wherein the bottom surface of the first length of non-metallic cable is releasably coupled to the top surface of the second length of non-metallic cable, wherein the first length of non-metallic cable comprises one circuit conductor having a first gauge and the second length of non-metallic cable comprises one circuit conductor having a second gauge, and wherein the first gauge of the circuit conductor of the first length of non-metallic cable is unequal to the second gauge of the circuit conductor of the second length of non-metallic cable, wherein the bottom surface of the first length of non-metallic cable is coupled to the top surface of the second length of non-metallic cable by materials selected from the group consisting essentially of cementatious material, glue, webbing material, heat-shrinkable material, material having complimentary parts which adhere to each other when pressed together, self-locking threaded fasteners, adhesive material, doublesided tape, adhesive polymeric strip, binding strip, and combinations thereof.

8. A coupled building wire assembly comprising:
a first length of non-metallic sheathed cable having a top surface and a bottom surface; and
a second length non-metallic sheathed cable having a top surface and a bottom surface;
wherein the bottom surface of the first length of non-metallic sheathed cable is releasably coupled to the top surface of the second length of non-metallic sheathed cable; and
wherein at least the top surface of the first length of non-metallic sheathed cable and at least the bottom surface of the second length of non-metallic sheathed cable are at least partly covered with a lubricant coating.

9. A coupled building wire assembly as defined in claim 8 wherein the lubricant coating comprises an aqueous emulsion of resins.

10. A coupled building wire assembly as defined in claim 8 wherein the lubricant coating includes at least one surfactant.

11. A coupled building wire assembly as defined in claim 8 wherein the lubricant coating is an emulsion containing a material selected from the group consisting essentially of organic esters, cross-linked polyolefins, fatty acids, and mixtures thereof.

12. A coupled building wire assembly as defined in claim 8 wherein the lubricant coating comprises water, at least one siloxane polymer, and isopropyl alcohol.

13. A coupled building wire assembly as defined in claim 8 wherein the first length of non-metallic sheathed cable comprises at least one circuit conductor having a first gauge and the second length of non-metallic sheathed cable comprises at least one circuit conductor having a second gauge, and wherein the first gauge of the at least one circuit conductor of the first length of non-metallic sheathed cable is substantially equal to the second gauge of the at least one circuit conductor of the second length of non-metallic sheathed cable.

14. A coupled building wire assembly as defined in claim 8 wherein the first length of non-metallic sheathed cable comprises at least one circuit conductor having a first gauge and the second length of non-metallic sheathed cable comprises at least one circuit conductor having a second gauge, and wherein the first gauge of the at least one circuit conductor of the first length of non-metallic sheathed cable is unequal to the second gauge of the at least one circuit conductor of the second length of non-metallic sheathed cable.

15. A coupled building wire assembly as defined in claim 8 wherein the bottom surface of the first length of non-metallic sheathed cable is coupled to the top surface of the second length of non-metallic sheathed cable by materials selected from the group consisting essentially of cementatious material, glue, webbing material, heat-shrinkable material, material having complimentary parts which adhere to each other when pressed together, self-locking threaded fasteners, adhesive material, double-sided tape, adhesive polymeric strip, binding strip, welding, and combinations thereof.

16. A coupled building wire assembly as defined in claim 15 wherein the lubricant coating comprises an aqueous emulsion of resins.

17. A coupled building wire assembly as defined in claim 15 wherein the lubricant coating includes at least one surfactant.

18. A coupled building wire assembly as defined in claim 15 wherein the lubricant coating is an emulsion containing a material selected from the group consisting essentially of organic esters, cross-linked polyolefins, fatty acids, and mixtures thereof.

19. A coupled building wire assembly as defined in claim 15 wherein the lubricant coating comprises water, at least one siloxane polymer, and isopropyl alcohol.

20. A coupled building wire assembly as defined in claim 15 wherein the binding strip is constructed of materials selected from the group consisting essentially of mylar, polyester, string, and combinations thereof.

21. A method of coating coupled building cables comprising:
providing a first length of non-metallic sheathed cable having a top surface and a bottom surface;
providing a second length non-metallic sheathed cable having a top surface and a bottom surface, wherein the bottom surface of the first length of non-metallic sheathed cable and the top surface of the second length of non-metallic sheathed cable having a configuration for releasable coupling to each other; and
covering at least a portion of at least one of the top surface of the first length of non-metallic sheathed cable and at least the bottom surface of the second length of non-metallic sheathed cable, respectively, with a lubricant coating.

22. The method of claim 21 wherein:
the lubricant coating includes at least one surfactant.

23. The method of claim 21 wherein:
the lubricant coating is an emulsion that includes at least one of organic esters, cross-linked polyolefins, and fatty acids.

24. The method of claim 21 wherein:
the lubricant coating includes water, at least one siloxane polymer, and isopropyl alcohol.

25. A coupled building wire assembly, comprising:
a first length of non-metallic sheathed cable having a first outermost sheath; and a second length of non-metallic sheathed cable having a second outermost sheath;
wherein the bottom surface of the first length of non-metallic sheathed cable is releasably coupled to the top surface of the second length of non metallic sheathed cable; and
wherein at least the top surface of the first outermost sheath and at least the bottom surface of the second outermost sheath have sufficient lubricant material incorporated therein to reduce the coefficient of friction of the exterior surfaces of the coupled building wire assembly, the lubricant material of the type that either migrates through, or permeates, said first and second sheaths to be available at the exterior surface of each of said first and second sheaths.

26. A coupled building wire assembly as defined in claim 25 wherein the lubricant material is selected from the group consisting essentially of saturated fatty esters, unsaturated fatty esters, modified organic acid derivatives, fatty acid amides, amide waxes, stearates, siloxanes, and mixtures thereof.

27. A coupled building wire assembly as defined in claim 25 wherein the first length of non-metallic sheathed cable comprises at least one circuit conductor having a first gauge and the second length of non-metallic sheathed cable comprises at least one circuit conductor having a second gauge, and wherein the first gauge of the at least one circuit conductor of the first length of non-metallic sheathed cable is substantially equal to the second gauge of the at least one circuit conductor of the second length of non-metallic sheathed cable.

28. A coupled building wire assembly as defined in claim 25 wherein the first length of non-metallic sheathed cable comprises at least one circuit conductor having a first gauge and the second length of non-metallic sheathed cable comprises at least one circuit conductor having a second gauge, and wherein the first gauge of the at least one circuit conductor of the first length of non-metallic sheathed cable is unequal to the second gauge of the at least one circuit of the second length of non-metallic sheathed cable.

29. A coupled building wire assembly as defined in claim 25 wherein the bottom surface of the first length of non-metallic sheathed cable is coupled to the top surface of the second length of non-metallic sheathed cable by materials selected from the group consisting essentially of cementitious material, glue, webbing material, heat shrinkable material, material having complimentary parts which adhere to each other when pressed together, self locking threaded fasteners, adhesive material, double-sided tape, adhesive polymeric strip, binding strip, welding, and combinations thereof.

30. A coupled building wire assembly as defined in claim 29 wherein the lubricant material is selected from the group consisting essentially of saturated fatty esters, unsaturated fatty esters, modified organic acid derivatives, fatty acid amides, amide waxes, stearates, siloxanes, and mixtures thereof.

31. A coupled building wire assembly as defined in claim 25 wherein the binding strip is constructed of materials selected from the group consisting essentially of mylar, polyester, string, and combination thereof.

32. A coupled building wire assembly as defined in claim 25 wherein the lubricant coating comprises water, at least one siloxane polymer, and isopropyl alcohol.
